(19) United States
(12) Patent Application Publication
(10) Pub. No.: US 2012/0218146 A1
(43) Pub. Date: Aug. 30, 2012

(54) Dynamic Sleep Time Calculation for GNSS Receiver

(75) Inventor: Maxime Leclercq, Encinitas, CA (US)

(73) Assignee: MaxLinear, Inc., Carlsbad, CA (US)

(21) Appl. No.: 13/218,363

(22) Filed: Aug. 25, 2011

Related U.S. Application Data
(60) Provisional application No. 61/377,416, filed on Aug. 26, 2010.

(51) Int. Cl. G01S 19/24; G01S 19/34

(52) U.S. Cl. 342/357.63; 342/357.74

(57) ABSTRACT

A GNSS receiver includes a sensing element for detecting an environmental condition, a control unit for dynamically calculating a sleep time duration in response to the environmental condition, and a digital processing unit that operates in a first mode or in a second mode based on the calculated sleep time duration and the environmental condition. The environmental condition may include a receiver signal strength indicator, a receiver velocity, the stability and precision of a local reference clock, a recent almanac, an ephemeris data, and the like. The first operation mode may include a tracking of satellite signals, and the second operation mode may include an acquisition operation, a tracking operation, or a combination of acquisition and tracking operations of satellite signals.

### CROSS-REFERENCES TO RELATED APPLICATIONS

The present invention claims benefit under 35 USC 119(e) of U.S. provisional application No. 61/377,416, filed Aug. 26, 2010, entitled “Dynamic Sleep Time Calculation for GNSS Receiver”, the content of which is incorporated herein by reference in its entirety.

### BACKGROUND OF THE INVENTION

Embodiments of the present invention relate to the field of Global Navigation Satellite Systems (GNSS), and more particularly, to techniques to dynamically reduce power consumption in a GNSS receiver.

Many commercial GNSS receivers are designed to be handheld, i.e., they can be carried by a user. In general, the user may not have access to an external power source to recharge the GNSS receiver. In order to extend the operation of the receiver, known power savings techniques resort to putting the receiver in a standby mode or sleep mode when the receiver is not in use. One technique is that the user manually switch off the receiver when it is not in use. Although this technique provides efficient power savings, it is, in general, not practical as the power-on time and the acquisition of the location information of the receiver will be unacceptably long. Because a GNSS receiver is intended to be used on a continuous basis, the receiver must keep ephemeris, received signal strengths of satellites, and other information in a standby state. A conventional power savings method is to power on a GNSS receiver during known time intervals to perform tracking operations or acquisitions during those intervals. This allows the receiver to sleep (or go into a power saving mode) for a limited time and then wake-up at fixed intervals to calculate its position. Conventional receivers thus have predictable sleep patterns, i.e., their sleep periods are pre-calculated given a rate of update or system calibration.

While users of handheld GNSS receivers appreciate the increase in battery life obtained by this method, they still expect to obtain even longer battery life while receiving location information at an acceptable interval.

### BRIEF SUMMARY OF THE INVENTION

In accordance with embodiments of the present invention, the sleep time of a GNSS receiver is dynamically calculated to account for variations in environmental data collected during the last active period. Receiver velocity, temperature, received signal strength, local clock stability and precision, motion and ephemeris validity may be used to compute the maximum sleep time that the system can tolerate to track or acquire satellite signals.

According to an embodiment of the invention, a GNSS receiver includes a sensing element configured to detect an environmental condition, a control unit configured to calculate a sleep time duration in response to the environmental condition, and a digital processing unit configured to operate in a first mode, in a second mode, or in a combination of first and second modes based on the calculated sleep time duration. In an embodiment, the environmental condition may include a receiver signal strength indicator. In another embodiment, the environmental condition may include a receiver velocity. In yet another embodiment, the environmental condition may include performance data of a local oscillator clock such as the stability and precision of a high quality temperature controlled crystal oscillator. In an embodiment, the first mode may include a tracking operation of satellite signals, and the second mode may include an acquisition operation, a tracking operation, or a combination of acquisition and tracking operations of the satellite signals.

Embodiments of the present invention also disclose a method for dynamically estimating a sleep time of a GNSS receiver. The method includes detecting an environment condition, calculating a sleep time duration in response to the environmental condition, and operating a first mode or a second mode of a digital signal processor based on the calculated sleep time duration. In an embodiment, the environmental condition may include at least one of a receiver signal strength indication signal, a receiver velocity, an ambient temperature, a reference clock frequency drift, and valid ephemeris data.

According to an embodiment, a machine readable media containing executable instructions which, when executing by a GNSS receiver, cause the receiver to perform a method of detecting an environment condition, calculating a sleep time duration in response to the environmental condition, and operating a first mode or a second mode of a digital signal processor based on the calculated sleep time duration. In an embodiment, the first mode may be a tracking operation of satellite signals, and the second mode may be an acquisition operation, a tracking operation, or a combination of an acquisition and tracking operations of satellite signals.

### BRIEF DESCRIPTION OF THE DRAWINGS

Preferred embodiments of the present invention are described below, by way of example only, with reference to the accompanying drawings, in which:

FIG. 1 is a block diagram illustrating a GNSS receiver according to an embodiment of the present invention;

2 is a flowchart diagram illustrating a process of dynamically calculating a sleep time interval during which a receiver of satellite signals remains idle or inactive, according to an embodiment of the present invention; and

FIG. 3 is a block diagram illustrating dynamic intervals for tracking and acquisition of a GNSS receiver according to an embodiment of the present invention.

### DETAILED DESCRIPTION OF THE INVENTION

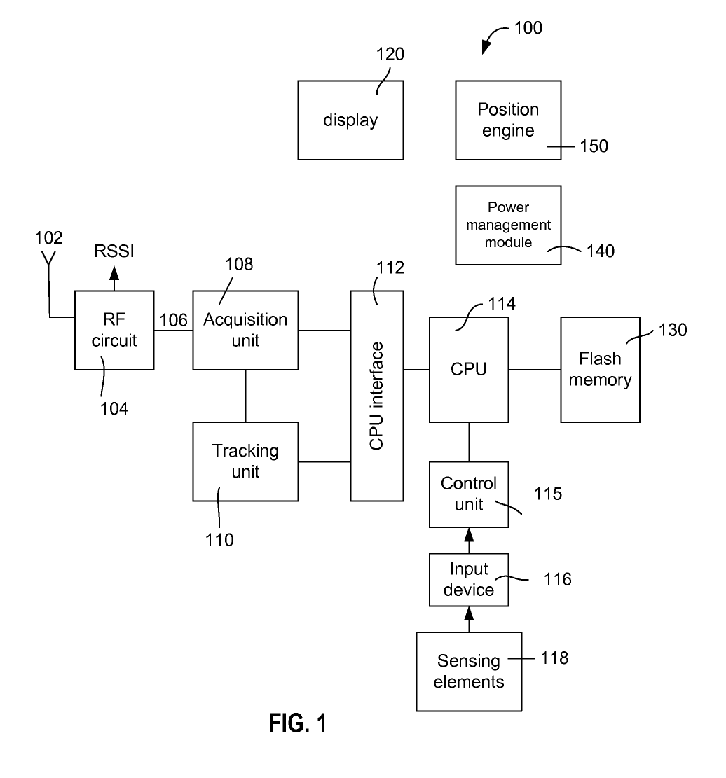

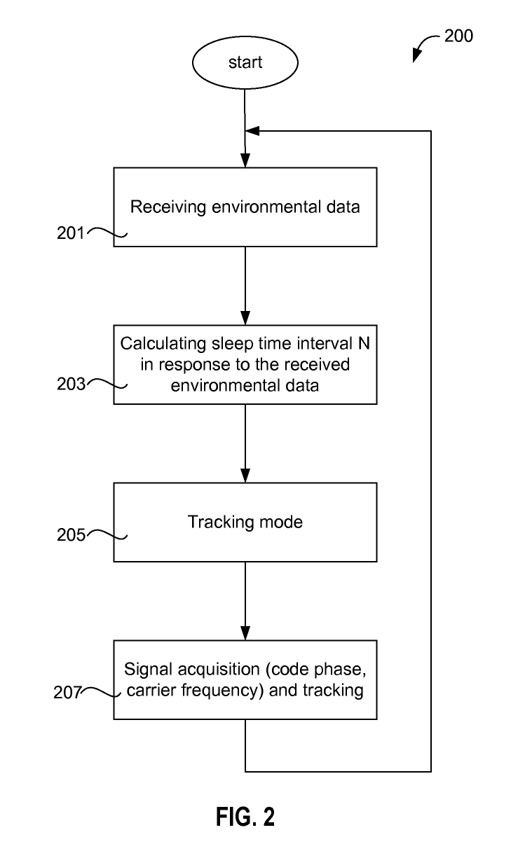

FIG. 1 is a block diagram illustrating a GNSS receiver 100 according to an embodiment of the present invention. Receiver 100 includes an antenna 102 for receiving GNSS satellite signals, a radio frequency (RF) circuit 104 coupled to the antenna 102 for downconverting the received signals to a baseband signal 106. Baseband signal 106 is provided to an acquisition unit 108 and a tracking unit 110 that provide the tracked and acquired satellite signals to a CPU 114 via a CPU interface unit 112. The GNSS receiver also includes an input device 116 for receiving environmental information provided by a user or by sensing elements 118. Sensing elements 118 can be, for example, temperature sensors, 2D/3D accelerometers, gyroscope, motion detectors, digital compass, local oscillator precision, ephemeris, and the like. The receiver includes one or more output devices 120 to display information to a user. An optional flash memory 130 coupled to the CPU provides instructions and data to operate the CPU including the acquisition and tracking units. A power management unit 140 provides the necessary power supplies for the operation of the receiver. The receiver may include a position engine 150 to calculate the position of the receiver and provide position information to a user via a display unit 120 which can be a LCD display in an embodiment.

In an embodiment, the receiver may include a control unit 115 that is capable of executing one or more sets of instructions and data stored in the flash memory. The control unit may be able to issue one or more control signals to set the receiver in a tracking mode, in an acquisition mode, or in a combination of acquisition and tracking modes. The control unit may also be able to set the receiver in a standby mode or a sleep mode to save power. In another embodiment, the control unit may be external to the CPU and operates together with the CPU to calculate a time duration for the sleep mode based on a user's input or information provided by the sensing elements. In an embodiment, the CPU may execute instructions stored in the flash memory to calculate the sleep time duration and passes on the time duration to the control unit for controlling the power management module, the RF circuit, the acquisition and tracking and the like.

The position of a person traveling at relatively high speeds (e.g. the user is in a train) changes rapidly. To provide a relatively accurate position, the sleep time of the receiver cannot be too long. In addition, if the satellite signal reception degrades, the receiver can anticipate a gap of coverage and thus decide based on this information and other variables to prematurely shut down or increase its rate of update. The next task to perform can also be calculated based on these variables. In order to make use of a GNSS signal coming from a particular satellite, the GNSS receiver first acquires and then track it. Acquisition is a more computationally demanding task, requiring a search across a three dimensional space of unknown time delay, Doppler shift, and the particular satellite. Therefore, once the signal of the particular satellite is acquired, the GNSS receiver may switch to a tracking mode. In some embodiments, the GNSS receiver may be designed based on a variable power management principle, where the power-on time of the receiver, i.e., the active operation of the receiver, may depend on environmental conditions. In an embodiment, if the GNSS receiver “knows” a priori the temperature characteristics of its local reference oscillator circuit, it may be equipped with a temperature sensor to receive periodically temperature information and compute the temperature difference to adjust its power-off duration before the reference frequency of the local reference oscillator drifts to an unacceptable level. In another embodiment, the GNSS receiver may be coupled to a 2D/3D accelerometer to compute the Doppler shift and adapts its power-off duration based on the Doppler shift. If the Doppler shift remains constant or equal to zero, the GNSS may assume that the user is traveling at a constant velocity or is stationary, the receiver may adjust the power-off time duration accordingly. In yet another embodiment, if the receiver signal strength indication (RSSI) signal shows a strong signal, the GNSS receiver may switch to an acquisition mode operation to acquire a new GNSS signal of a particular satellite. Or if the RSSI signal is weak, the GNSS receiver may switch to a tracking mode operation. The GNSS receiver is designed to operate autonomously by executing algorithms stored in the CPU memory. In some embodiments, if environmental data such as temperature, velocity, receiver strength signal, and the like is not available, the GNSS may set itself to an idle mode or standby mode at a fixed time interval for a predetermined duration to conserve power. That is, the GNSS receiver may not require external data to operate in a power saving mode. However, if environmental information is available, the GNSS may make use of it to dynamically calculate time intervals during which the receiver performs tracking operations.

FIG. 2 is a flowchart diagram illustrating a process 200 of dynamically calculating a sleep time interval during which a receiver of satellite signals is set in a non-operational or sleep mode, in accordance with an embodiment of the present invention. The process shown in FIG. 2 may include executable machine codes or algorithms that are stored in a machine readable media such as the flash memory and executed by the CPU as shown in FIG. 1. The process starts with reading environmental data using certain sensing elements described in above sections (step 201). Based on the obtained environmental data, the receiver may dynamically calculate a sleep time interval where the receiver is not active (step 203). The sleep time interval N varies depending upon the measured data (e.g., velocity, temperature, frequency drift) or a priori information such as a recent almanac or a valid ephemeris or a combination thereof. Based on the obtained environmental data, the receiver may operate in a tracking mode (step 205) and/or in an acquisition and tracking mode (207). In an embodiment, the satellite signals are acquired using the antenna and downconverted by the radio frequency module to a convenient intermediate frequency or baseband signal for demodulation. Once the satellite signals have been acquired and demodulated, there will be significantly shorter time for subsequent reacquisition and tracking operations. That is, the subsequent tracking time may be significantly shorter than that of a normal acquisition and tracking operation so that the receiver can be put in a sleep mode longer to further conserve power. In an exemplary embodiment, if during the interval N, signal reception and sky condition is good (e.g., outdoor in a suburban area) the sleep time can be increased significantly and the receiver may perform short acquisition instead of tracking, or the receiver may track for a shorter amount of time. The process may go back to step 203 and repeats the cycle anew.

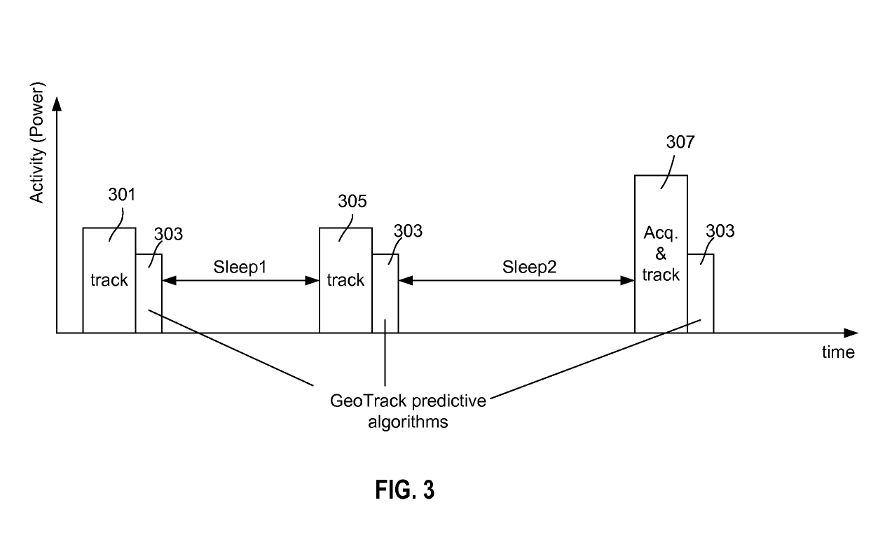

FIG. 3 shows the dynamically calculated time intervals during which a GNSS receiver, in accordance with embodiments of the present invention, performs tracking operations to account for variations in environmental data such as velocity, temperature, received signal strength and ephemeris. Referring to FIG. 3, the receiver may be operating in a tracking mode 301 (step 205 in FIG. 2). The receiver may read in environmental data 303 and dynamically calculate a sleep time period (indicated as Sleep1) during which the receiver may be switched off to conserve power. An internal timer may be set and count down to wake up the receiver. Upon awakening, the receiver may be operating in a tracking mode and not an acquisition mode that is much more computationally demanding based on the received or measured data (e.g., valid ephemeris, temperature, velocity variation, and the like). However, if the environmental data indicates that during the period N, signal reception and sky condition is good (e.g., outdoor in a suburban area) the sleep time can be increased significantly (indicated as Sleep2) and the receiver may perform acquisition and tracking operations 307. As it should be appreciated, the sleep times Sleep1 and Sleep2 may not be equal, and the operations of the GNSS receiver after a sleep time Sleep1 and Sleep2 may not be the same based on Geotrack predictive algorithms stored in the flash memory and executed by the CPU during period 303.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims.

What is claimed is:

1. A GNSS receiver comprising:
a sensing element configured to detect an environmental condition;
a control unit configured to calculate a sleep time duration in response to the environmental condition; and
a digital processing unit configured to operate in a first mode or in a second mode or a combination of both in response to the calculated sleep time duration.

2. The GNSS receiver of claim 1, wherein the environmental condition comprises a receiver signal strength indication (RSSI) signal.

3. The GNSS receiver of claim 1, wherein the environmental condition comprises a receiver velocity or acceleration.

4. The GNSS receiver of claim 1, wherein the environmental condition comprises a reference clock frequency drift.

5. The GNSS receiver of claim 1, wherein the environmental condition comprises valid ephemeris data.

6. The GNSS receiver of claim 1, wherein the first mode comprises a tracking operation of satellite signals and the second mode comprises an acquisition operation, a tracking operation, or a combination of the acquisition and tracking operations of the satellite signals.

7. The GNSS receiver of claim 1, wherein the environmental condition comprises at least one of an ambient temperature, a velocity or acceleration of the receiver, a reference frequency drift, valid ephemeris data, and a received signal strength indicator signal.

8. A method for dynamically estimating a sleep time, the method comprising:
detecting an environment condition;
calculating a sleep time duration in response to the environmental condition; and
operating a first mode or a second mode of a digital signal processor in response to the calculated sleep time duration.

9. The method of claim 8, wherein the environmental condition comprises a receiver signal strength indication signal.

10. The method of claim 8, wherein the environmental condition comprises a receiver velocity.

11. The method of claim 8, wherein the environmental condition comprises a reference clock frequency variation.

12. The method of claim 8, wherein the environmental condition comprises valid ephemeris information.

13. The method of claim 8, wherein the first mode comprises a tracking operation of satellite signals and the second mode comprises an acquisition operation, a tracking operation, or a combination of acquisition and tracking operations of the satellite signals.

14. A machine readable media containing executable instructions which when executing by a GNSS receiver cause the receiver to perform a method comprising:
detecting an environment condition;
calculating a sleep time duration in response to the environmental condition; and
operating a first mode or a second mode of a digital signal processor in response to the calculated sleep time duration.

15. The machine readable media of claim 14, wherein the environmental condition comprises one of an ambient temperature, a velocity or an acceleration of the GNSS receiver, a receiver signal strength indicator signal, a reference frequency drift, valid ephemeris data, or a combination thereof.

16. The machine readable media of claim 14, wherein the first mode comprises a tracking operation of satellite signals and the second mode comprises an acquisition operation, a tracking operation, or a combination of acquisition and tracking operations of the satellite signals.
